(19) United States
(12) Patent Application Publication
(10) Pub. No.: US 2009/0066729 A1
(43) Pub. Date: Mar. 12, 2009

(54) Real-time display of measurement array data for handheld computing devices in communication with instruments

(76) Inventor: Steve Sabram, (US)

Correspondence Address: Philip Thomas Virga, 1525 Aviation Blvd. #105, Redondo Beach, CA, 90278, US

(21) Appl. No.: 12/283,384

(22) Filed: Sep. 10, 2008

Related U.S. Application Data
(60) Provisional application No. 60/993,320, filed on Sep. 10, 2007.

(51) Int. Cl. G09G 5/00; G06F 3/048

(52) U.S. Cl. 345/660; 715/781

(57) ABSTRACT

The present invention provides a method for a handheld computer with a graphical display showing multiple points of data in real-time from a microcontroller-driven analog measurement instrument via a low speed, wired or wireless transport. A finite amount of measurements are taken at a predetermined interval from a sensor wherein the measurements are converted into a digital word using an Analog to Digital converter and a high speed microcontroller performing all the timing operations to read the sensor. The measurements read from the Analog to Digital converter are then stored in a signal buffer where mathematical transformations, such as integrations and domain conversions are done on the signal buffer as instructed from software running on a client machine. Once the desired transformations are complete either all or a contiguous subset of the measurements are scaled to an array of integers that denote display coordinates in a predetermined viewing area on the clients LCD display. This display coordinate integer array is then compressed before it is sent to the client for viewing via either a wired serial transport or a wireless serial transport.

### CROSS-REFERENCE TO PROVISIONAL APPLICATION

Attention is directed to provisional application No. 60/993,320, filed Sep. 10, 2007, entitled “Real-Time, Display of Measurement Array Data for Handheld Computing Devices in Communication with Instruments,” Attorney Docket No. S/S1011. The disclosure of this provisional application is hereby incorporated by reference in its entirety.

### BACKGROUND

1. Field of the Invention

This invention relates generally to handheld measurement devices and, in particular, to real-time display of measurement array data for handheld measurement devices.

2. Background

A typical handheld measurement system consists of software and simple hardware attachments for a given PDA (personal digital assistant) such as the Palm or handheld computer. Sensors are attached to the hardware, turning the Palm or handheld computer into a state-of-the-art, handheld test and measurement instrument. Handheld computing devices have become smaller and more powerful, thereby providing the user with unprecedented access to desired information when mobile. For example, wireless telephones and personal digital assistants (“PDAs”) equipped with wireless modems, when provided with the appropriate software, also permit the user to browse a network and look for information of interest.

Despite these advances in hardware and software, the sheer volume of measurement information from a plurality of sensors can overwhelm the user. Graphical user interfaces that provide multiple views of related measurement information (such as frames, panes, or screens) are prevalent in commercially available software products. These interfaces tend to facilitate user interaction with information presented. Unfortunately, real-time display of measurement data is severely limited by the lack of intuitive, hierarchical relationships between views, view placement and layout, and view presentation. That is, there is little user level control over the real-time relationships between views, view placement and layout, and view presentation of measurement data, particularly for handheld measurement devices.

From the foregoing, it is apparent that there is still a need for a way to view real-time measurement information or measurement array data on a small screen in a handheld measurement devices and systems in an efficient manner.

### SUMMARY

The present invention provides a method for a handheld computer with a graphical display showing multiple points of data in real-time from a microcontroller-driven analog measurement instrument via a low speed, wired or wireless transport. A finite amount of measurements are taken at a predetermined interval from a sensor wherein the measurements are converted into a digital word using an Analog to Digital converter and a high speed microcontroller performing all the timing operations to read the sensor. The measurements read from the Analog to Digital converter are then stored in a signal buffer where mathematical transformations, such as integrations and domain conversions are done on the signal buffer as instructed from software running on a client machine. Once the desired transformations are complete either all or a contiguous subset of the measurements are scaled to an array of integers that denote display coordinates in a predetermined viewing area on the clients LCD display. This display coordinate integer array is then compressed before it is sent to the client for viewing via either a wired serial transport or a wireless serial transport.

Other features and advantages will be apparent to one skilled in the art given the benefit of the following disclosure.

### BRIEF DESCRIPTION OF THE DRAWINGS

Other objects, features, and advantages of the present invention will be apparent from the written description and the drawings in which:

FIG. 1 is a plan front view of a measurement sled of the present invention;

FIG. 2 is a side view of the measurement sled of FIG. 1;

FIG. 3 is a planar side view illustrating the measurement sled attaching to a handheld computer or PDA;

FIG. 4 is a plan front view of a handheld computer or PDA with the measurement sled connected and attached underneath forming a handheld measurement system;

FIG. 5 illustrates a system level block diagram of the handheld measurement system;

FIG. 6 is a pictorial representation of the graphical user interface illustrating an example of varying the frames and panes on the handheld computer or PDA;

FIG. 7 is a flowchart illustrating one example of the logic for implementing a real-time measurement array display; and

FIG. 8 is a flowchart illustrating one embodiment of the method for the frame management dynamics illustrated in FIG. 6.

### DETAILED DESCRIPTION

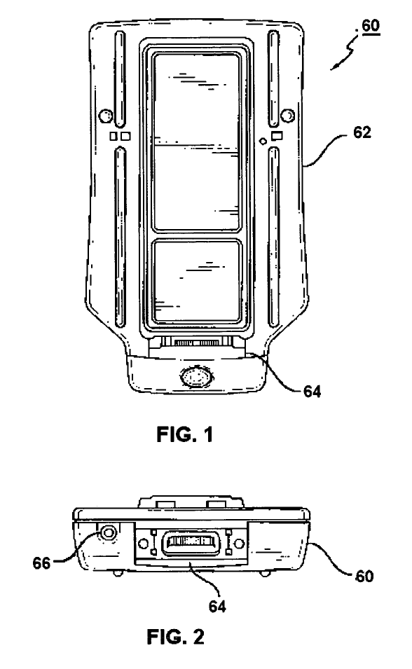

Most PDAs (personal digital assistants) have the ability to have a “sled” attached to the bottom/back of the device. Typically, a sled is used for a wired or wireless communications device such as a modem or Ethernet connection. Referring to FIGS. 1 through 4 there is shown a small, lightweight peripheral or sled 60 that attaches securely to the back of a PDA device 70 which by way of example may be a Palm handheld. When combined with the software of the present invention, the appropriate cable, and environmental sensors such as a user's ICP.®. accelerometers for example, it becomes the first complete, PDA-based multipurpose instrument 78 for vibration analysis and analog data acquisition for ICP accelerometers and other sensors, as shown in FIG. 4. By adapting a stock plastic case and placing inside a micro-controller-based, analog-to-digital converter system to which sensors are attached an entire measurement system combining PDA, sled, and sensors provide for a wide range of test and measurement applications.

Although not shown in the figures, it should be understood that the design approach is to use a “split board” design within the sled wherein one end of the board is the “logic board,” which holds the micro-controller or DSP (digital signal processor) and communicates with the PDA. The other end of the board is the “interface board,” which holds the analog or digital electronics to communicate with the sensors. Although the boards are fabricated as one, they are designed so that the two ends can be cut apart and rejoined 72 with multi-contact connectors. This allows for the possibility of new logic-board designs and/or new interface-board designs being created and joined with existing designs while minimizing design, fabrication, and assembly time and costs.

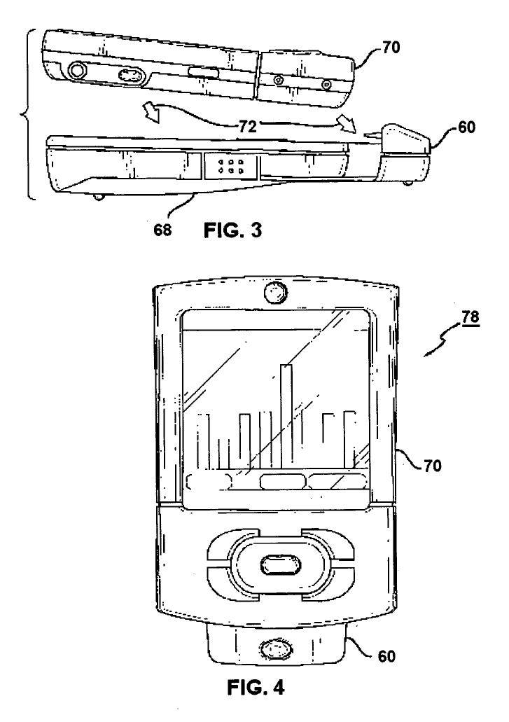

Referring once again to FIGS. 1 through 4, the measurement sled 60 may provide from four to eight single-ended analog inputs and provides one 16-bit digital counter, one TTL-level digital-switch input line, and two TTL-level digital-switch output lines. As shown in FIGS. 3 and 4, the measurement sled 60 firmly attaches and de-attaches to any Palm.™. Tungsten.™. T, T2, T3 30, or C or Garmin iQue 3200 or iQue 3600 handheld by utilizing mechanical hooks 62 and hook releases 68. High-impedance inputs ensure compatibility with almost any active analog sensor. An integrated 20-pin connector 64 features a harpoon latch for a more secure connection and is shielded for low noise. The measurement sled 60 may be powered by a pair of on-board AAA alkaline batteries (not shown) or by an optional external power supply through power connector port 66 as shown in FIG. 2.

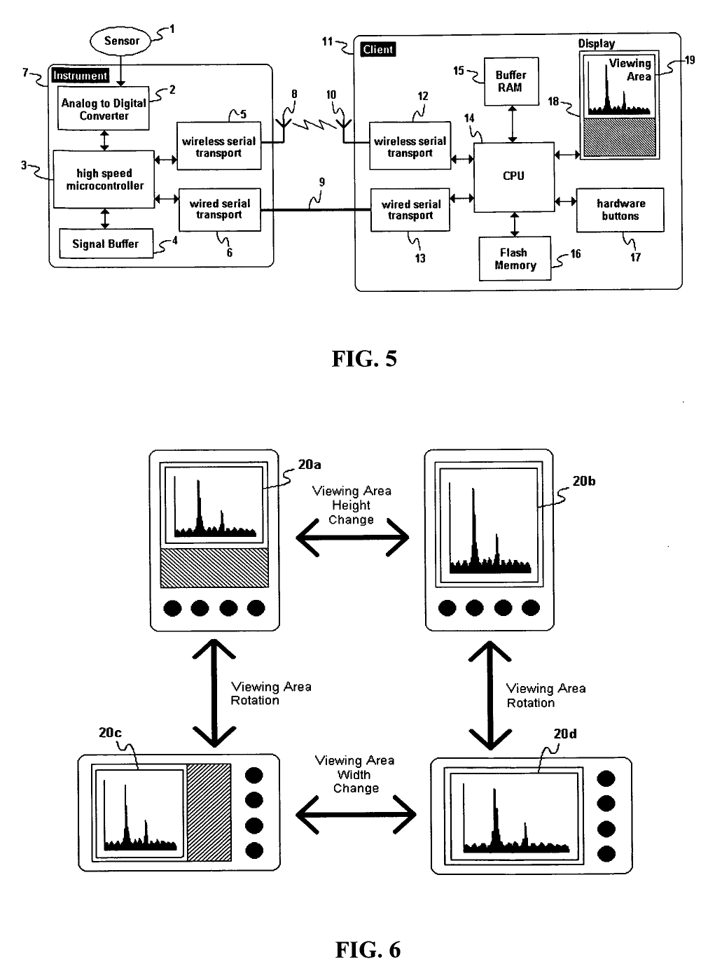

FIGS. 5 through 8 describes a method for a handheld computer with a graphical display to show multiple points of data in real-time from a microcontroller-driven analog measurement instrument via a low speed, wired or wireless transport. This becomes possible by taking advantage of the small screen size of most handheld computers by knowing the end user expecting to see a small amount of data with a handful of points animating to show changes in the data. The specific system features needed for this scheme involves two separate devices shown in FIG. 5. First is the measurement instrument 7 and second a client machine 11 (typically a handheld computer) with a graphical, LCD display 18 linked together by either a slow speed asynchronous serial line 9 or a pair of radio antennas 8 and 10.

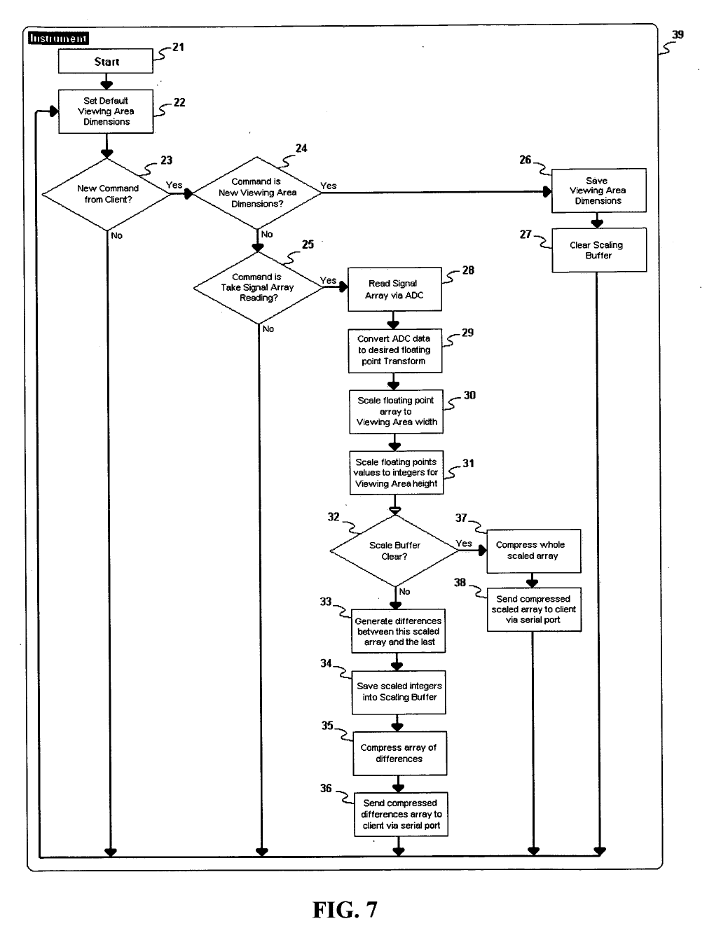

Referring once again to FIG. 5, to begin with a finite amount of measurements are taken at a predetermined interval from a sensor 1. These measurements are then converted into a digital word using an Analog to Digital converter 2 wherein a high speed microcontroller 3 performs all the timing to read the sensor. The measurements read from the Analog to Digital converter are then stored in a signal buffer 4 where mathematical transformations, such as integrations and domain conversions are done on the buffer as instructed from the software running on the client machine 11. Once the desired transformations are complete either all or a contiguous subset of the measurements are scaled, (as will be described below using the flowchart shown in FIG. 7) to an array of integers that denote display coordinates in a predetermined viewing area on the client LCD display 18. This display coordinate integer array is compressed before it is sent to the client via either a wired serial transport 6 or a wireless serial transport 5.

The display compressed integer array is then received by the client device 11 by the corresponding wired serial transport 12 or wireless serial transport 13. These serial ports are under the control of the client devices Central Processing Unit 14 which runs software that is held in flash memory 16. The received compressed integer array is decompressed and stored in a buffer RAM 15. The integer array is now displayed on the client machines display 18 in a predefined Viewing Area 19 within the display in to show the array graphically. The viewing area size can be changed via hardware buttons 17 on the client device that may be virtually represented on parts of the screen.

Turning now to FIG. 6, the integer array representing the measurements 20a is show in the Viewing Area in an x-y vector or histograph plot to represent the transformed floating point data present in the Instrument. The display can be rotated 20c or have its height change 20b or have its width changed 20d in many different permutations as the user pleases.

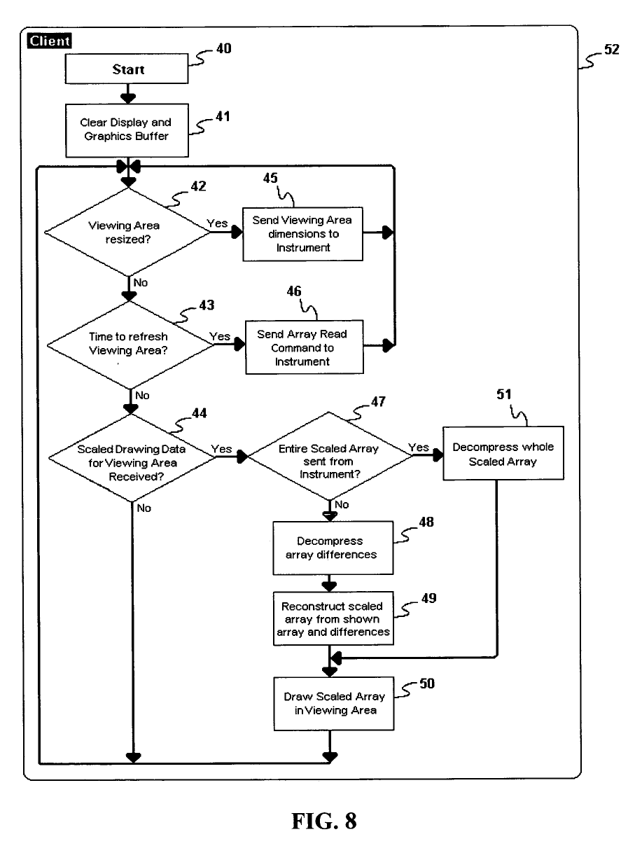

FIG. 7 illustrates one example of a logic diagram for implementing a real-time measurement array display scheme. FIG. 7 shows the Instrument logic while FIG. 8 shows the Client logic. Both of these logics are embedded in respective software applications in the Instrument and Client. The Instrument 39 starts the software 21 by setting default values for the size of the viewing area 22 and starts to accept command instructions from the Client 24 via one of the serial transports. Once a command is received, it is checked to see if this command involves new client viewing area dimensions 24 or a command to take readings for an array of sensor measurements 25. If the command is a new viewing area size, the new viewing area dimensions are saved in microcontroller memory 26 and the scaling buffer is cleared 27.

Referring once again to FIG. 7 if the command is to take a measurement array reading, a routine is called that will take a predefined amount of measurements at a predefined frequency via the Analog to Digital Converter 28 and store it in the Signal Buffer 4. The raw data form the Analog to Digital converter 28 is then transformed into the desired representation of the signal 29 such as time domain or frequency domain which may include integration of said domain signal to represent such qualities as acceleration, velocity or displacement of the phenomena measured by the Sensor 1.

Once this transformation is complete, the signal needs to be scaled to represent it graphically on the Client machine. First the number of points in the transformed array is compared to the pixel width of the viewing area saved 30. Then the consolidated floating point values are scaled to integer values based on the height of the stored viewing area 31. A complete scaled, integer array is now determined for display on the Client.

Next a check is made to see if this integer array is the first for the stored client viewing area size 32. If this is the first integer array for the current viewing area size, the entire scaled array is sent to the client. This is done by compressing the entire integer array 37 by checking for redundant patterns and then sending it to the client by the selected serial transport 36.

If this is not the first scaled array of the current viewing area size, the differences in each corresponding integer of the array is determined 33 and saved in the scaling buffer 34. This array of differences is compressed 35 and sent to the client via the selected serial transport 36 for client display.

The Instrument is primarily controlled by Client 52 commands generated by user actions and Client timing. Referring to FIG. 8 within the client, the software application starts 40 by clearing both the display and graphic buffers that shows the integer array that represents the measurement array within the instrument. At the beginning of the client application or from a user action the viewing area may be resized 42 wherein this action creates and sends to the instrument a command with the new viewing area dimensions 45.

The user also has the ability to control the real-time, refresh rate of the integer array that represents the measurement array in the instrument in the viewing area of the client. When the client application timer determines that it is time to refresh the viewing area 43 a command is composed to tell the Instrument to provide scaled integer array data 46. The client then waits for a response from the Instrument of scaled integer array data for display 44.

Lastly, the integer array data from the Instrument is then examined to see if it is an entire scaled array or differences of already displayed integer array 47. If it is an entire array, the integer array data is decompressed 51 and directly drawn to the viewing area 50. If the command contains difference data, the difference data is decompressed 48 and the scaled array is reconstructed from the difference data and the already displayed integer array 49. This is done in a continuous manner to show real-time array data from the Instruments sensor 'til the user terminates the data stream.

The scope of the invention is, therefore, indicated by the appended claims, rather than by the foregoing description. All changes which come within the meaning and range of equivalency of the claims are to be embraced within their scope.

What is claimed is:

1. A method for a handheld computer having a graphical display for showing multiple points of data in real-time from a microcontroller-driven analog measurement instrument via a low speed, wired or wireless transport, comprising:
performing a finite amount of measurements taken at predetermined intervals from a sensor by the measurement instrument wherein said finite amount of measurements are converted into a digital word using an Analog to Digital converter and a high speed microcontroller performing all the timing operations to read the sensor;
storing said finite amount of measurements in a signal buffer of the handheld computer wherein mathematical transformations are executed on said finite amount of measurements within said signal buffer as instructed from software running on the handheld computer; and
scaling either all or a contiguous subset of said transformed measurements into an array of integers that denote display coordinates in a predetermined viewing area on the graphical display of the handheld computer wherein said display coordinate integer array is then compressed before it is serially transported to the handheld computer for viewing.

2. The method for a handheld computer having a graphical display for showing multiple points of data in real-time according to claim 1, further comprising:
setting default values for the size of a viewing area by the analog instrument wherein the measurement instrument accepts command instructions from the handheld computer via serial transports.

3. The method for a handheld computer having a graphical display for showing multiple points of data in real-time according to claim 2, further comprising:
receiving a command from the handheld computer and checking if this command involves new graphical display viewing area dimensions wherein if the command is a new viewing area size said new viewing area dimensions are saved in microcontroller memory and said signal buffer is cleared.

4. The method for a handheld computer having a graphical display for showing multiple points of data in real-time according to claim 2, further comprising:
receiving a command from the handheld computer to take readings for an array of sensor measurements wherein a routine is called for performing a predefined amount of measurements at a predefined frequency via the Analog to Digital Converter and storing it in said signal buffer.

5. The method for a handheld computer having a graphical display for showing multiple points of data in real-time according to claim 4, further comprising:
transforming data from said Analog to Digital converter into a desired representation of a domain signal such as time domain or frequency domain which may include integration of said domain signal to represent such qualities as acceleration, velocity or displacement of the phenomena measured by the sensor.

6. The method for a handheld computer having a graphical display for showing multiple points of data in real-time according to claim 5, further comprising:
scaling said transformed domain signals for graphical representation on the handheld computer wherein a number of points in said transformed array is first compared to a pixel width of a viewing area saved and then consolidated floating point values are scaled to integer values based on a height of a stored viewing area wherein a complete scaled, integer array is now determined for display on the handheld computer.

7. The method for a handheld computer having a graphical display for showing multiple points of data in real-time according to claim 6, further comprising:
checking to see if said integer array is a first stored integer array for said graphical display viewing area size wherein if this is said first integer array for a current viewing area size, the entire scaled array is sent to the handheld computer by compressing said entire integer array and checking for redundant patterns and then sending it to the handheld computer via said selected serial transport.

8. The method for a handheld computer having a graphical display for showing multiple points of data in real-time according to claim 6, further comprising:
checking to see if said integer array is a first stored integer and if it is not the first stored integer array of a current viewing area size, the differences in each corresponding integer of said array is determined and saved in said scaling buffer wherein said array of differences is compressed and sent to the handheld computer via said serial transport for handheld computer graphical display.

9. The method for a handheld computer having a graphical display for showing multiple points of data in real-time according to claim 1, further comprising:
clearing both display and graphic buffers by the handheld computer that shows an integer array that represents a measurement array within the instrument at a beginning of a client application or from a user action wherein said viewing area may be resized and this action creates and sends to the measurement instrument a command with new viewing area dimensions.

10. The method for a handheld computer having a graphical display for showing multiple points of data in real-time according to claim 9, further comprising:
controlling a real-time, refresh rate of said integer array by a user which represents a measurement array in the measurement instrument in said viewing area of the handheld computer.

11. The method for a handheld computer having a graphical display for showing multiple points of data in real-time according to claim 10, further comprising:
determining using a client application timer that it is time to refresh said viewing area with a software command composed to tell the measurement instrument to provide scaled integer array data wherein the handheld computer then waits for a response from the measurement instrument of scaled integer array data for display.

12. The method for a handheld computer having a graphical display for showing multiple points of data in real-time according to claim 11, further comprising:
examining said integer array data from the measurement instrument to determine if it is an entire scaled array and if it is an entire scaled array said integer array data is decompressed and directly drawn to said graphical viewing display.

13. The method for a handheld computer having a graphical display for showing multiple points of data in real-time according to claim 11, further comprising:
examining said integer array data from the measurement instrument to determine if differences of already displayed integer exist and if the command contains difference data, the difference data is decompressed and the scaled array is reconstructed from the difference data and the already displayed integer array.

14. The method for a handheld computer having a graphical display for showing multiple points of data in real-time according to claim 1 wherein said serial transport is wirelesss.

15. The method for a handheld computer having a graphical display for showing multiple points of data in real-time according to claim 1 wherein said serial transport is wired.
